(19) United States
(12) Patent Application Publication
(10) Pub. No.: US 2025/0093838 A1
(43) Pub. Date: Mar. 20, 2025

(54) METHOD AND DEVICE FOR TOOL DATA EXCHANGE

(71) Applicant: DMG MORI Digital GmbH, Bielefeld (DE)

(72) Inventors: Maruan SHANIB, Hannover (DE); Jens DAMM, Bielefeld (DE)

(21) Appl. No.: 18/882,576

(22) Filed: Sep. 11, 2024

(30) Foreign Application Priority Data
Sep. 14, 2023 (DE) 102023124850.2

(51) Int. Cl. G05B 19/402; G05B 19/408

(52) U.S. Cl. CPC G05B 19/402; G05B 19/408

(57) ABSTRACT

A method for processing tool data on a machine tool having a data interface for connection to a tool management system and an associated control device and computer program product. The method comprises the steps of: acquiring a unique tool identifier, WID, of a tool to be picked up; matching the acquired WID with previously known tool identification data of the machine tool; if it is determined that the tool to be picked up is not yet known and/or updated tool data for the WID are available: automatically, via the data interface, retrieving tool data directly from the tool management system based on the acquired WID or automatically retrieving the tool data directly from the tool to be picked up; determining a loading location for the tool to be picked up based on the retrieved tool data and preferably, picking up the tool at the determined loading location.

### CROSS-REFERENCE TO RELATED APPLICATIONS

The present application claims priority to DE102023124850.2, filed Sep. 14, 2023, which is hereby incorporated herein by reference as if set forth in full.

The present invention relates to a method for processing tool data on a machine tool having a data interface for connection to a tool management system and an associated control device and computer program product.

### BACKGROUND

In the prior art, it is known to control the workpiece machining on numerically controlled machine tools by means of an NC control device which is usually integrated on the machine tool. In particular, the NC control device controls controllable actuators, for example spindle drives, axle drives of axles of the machine tool and further machine functions of the machine tool, for example on the basis of an NC program generated by a CAD/CAM system or programmed by a machine operator.

DE 10 2006 043 390 A1 describes a device and a method for simulating a sequence for machining a workpiece on a machine tool. The described approach is characterized by an integrated simulation approach. In particular, the PLC movement sequences of the machine tool are also simulated with the aid of a PLC control device and a PLC sequence simulation device. As a result, a realistic simulation of a machine tool in all its essential aspects is possible.

In EP 2 891 020 A1, an extended control of a numerically controlled machine tool has been proposed, in which a further control device or operating device is provided in addition to the NC control device, which extends the operation or control of the operator of the machine tool in relation to the functions of an NC control device.

Tool and tool data management in the field of machine tools currently represents a very great challenge and, in particular, there are currently a wide variety of ways in which tools with corresponding data come into contact with the machine. On the machine tool side, for this purpose it is in particular necessary for the tool data to be input in order to be able to be used in the control and therefore a specific data format is required. Furthermore, current presetting devices are usually designed to be operated by a human operator via a manufacturer-specific user interface. The precise operating steps, the designations and the presentation of the data differ here from manufacturer to manufacturer. Corresponding APIs are not available here. On account of these hurdles, automation in the machine tool controller also represents a central problem in particular with regard to the processing of the tool data. However, tool data which are as precise as possible are indispensable for modern manufacturing processes in order to enable efficient and effective use of the tools and machine tool.

It is therefore an object of the present invention to provide a system, a device or a method with which the operation or control of a machine tool is extended and improved, in particular with regard to the operability of the machine tool with regard to automation, in order to achieve efficient manufacture of workpieces by the machine tool.

### SUMMARY

To achieve the above-described object, a method for processing tool data on a machine tool according to claim 1 as well as systems, devices and methods according to the independent claims are proposed. Dependent claims relate to preferred and particularly expedient exemplary embodiments.

According to a preferred embodiment, the following is proposed: A method for processing tool data on a machine tool (in particular on the control device of the machine tool) having a data interface for connection to a tool management system. The method steps include in particular: acquiring a unique tool identifier, hereinafter referred to as “WID”, of a tool to be picked up, and subsequently matching the acquired WID with previously known tool identification data of the machine tool. If it is determined that the tool to be picked up is not yet known and/or updated tool data for the WID are available, then firstly tool data based on the acquired WID are automatically retrieved directly (and preferably directly) from the tool management system via the data interface. Preferably, a manual intervention is therefore no longer necessary for this purpose. Alternatively, the tool data are automatically retrieved directly (and preferably instantaneously) from the tool to be picked up. The tool data are therefore directly available in the WZM controller, for example NC control device. In the next step, a loading location for the tool to be picked up is determined based on the retrieved tool data, and preferably the tool is also picked up at the determined loading location. As a result of this configuration, an automated and efficient acquisition of the necessary (and current) tools with tool data is possible which can be used directly in the production process in order thus to significantly improve the efficiency in the use of the machine tool and in particular in the manufacture of workpieces. In addition, errors and waiting times in the tool acquisition/input are reduced or entirely avoided.

In preferred exemplary embodiments, acquiring the WID also comprises scanning a tool identification identifier of the tool to be picked up. In this case, the WID can be a unique identification (for example UUID—Universally Unique Identifier) which uniquely identifies the specific tool globally and thus enables a reliable and rapid acquisition of the tool.

In preferred exemplary embodiments, the tool management system is an external tool management system for providing data, for example from the cloud, and the data interface is a tool data interface which is connected to the external tool management system via a network connection. In this case, the term “external” preferably relates to the machine tool, so that an external data management system is a system which is provided externally and preferably independently of the individual machine tool. A tool management system can be, in particular, a system of resource management with which some or all available tools comprise master data (for example as part of the tool data) and an up-to-date documentation about tool data, maintenance status and the readiness of the tools for use (specific statements about the tool availability at any time). In addition, the tool data of the tool management system can comprise a tool history. The tool history can indicate all events from the planning via the introduction of the tool to the actual working periods in which the tool was in use. As a result of the automated provision of these comprehensive tool data by means of WID, efficient and precise use of the machine tool is thus enabled. Provision of the data via the external tool management system offers the possibility of a decentralized and flexible provision of the data for different machine tools.

In preferred exemplary embodiments, the tool data comprise measured values and/or setting values of the tool which have been determined by an external device, in particular a presetting, balancing or shrinking device. These specific data are advantageous in particular for the even more precise use of the tool on the machine tool, wherein the individual provision of the data via the automated data retrieval has the particular advantage that the most up-to-date measured values and/or setting values of the tool which is actually to be replaced are automatically available on the machine tool and the production sequence can be designed efficiently and precisely.

In preferred exemplary embodiments, in order to create a difference list, the tools required for a machining assignment are compared with the tools already present, and one or more tools to be replaced can be determined on the basis of the difference list. In this advanced embodiment, not only are the specific tool data automatically retrieved, but it is additionally also determined automatically for the specific production task or machining assignment which tools are required. The machining assignment can be in particular a CNC or NC program for producing one or more components.

In preferred exemplary embodiments, an NC program is scanned for required tools, and a corresponding difference list is preferably created. In this advanced embodiment, not only are the specific tool data automatically retrieved, but it is additionally also determined automatically for the specific production task or machining assignment which tools are required. The machining assignment can be in particular a CNC or NC program for producing one or more components.

In preferred exemplary embodiments, a predetermined setup location for the tool to be replaced is determined. In this advanced embodiment, not only are the specific tool data automatically retrieved, but an optimal setup location for the tool to be replaced (which is still necessary for the execution of the specific production task or machining assignment and is still to be replaced on the machine tool or tool magazine) is additionally also determined automatically.

In preferred exemplary embodiments, a setup sequence of the tools is additionally determined depending on a machining assignment, so that the loading locations of the tools are determined according to the machining assignment. In this advanced embodiment, not only are the specific tool data automatically retrieved, but an optimal setup location for all required tools will additionally also be determined automatically.

In preferred exemplary embodiments, the previously known tool identification data are stored on a memory on the machine tool, in particular an internal memory of the machine tool or the machine tool controller. A rapid retrieval of the data in the production process is thus enabled and the production sequence can be designed efficiently and precisely.

In preferred exemplary embodiments, the WID and/or tool data are attached directly to the tool or tool holder in a machine-readable manner in order to be retrieved by scanning. A rapid retrieval of the data in the production process is thus enabled and the production sequence can be designed efficiently and precisely.

In preferred exemplary embodiments, the tool data are stored in at least one of the following ways:
the tool data and/or the WID are stored in a database;
the tool data and/or the WID are permanently attached to the tool, in particular as an engraved code or printed 2D code;
the tool data and/or the WID are temporarily stored on the tool, in particular as a printed sticker; and/or
the tool data and/or the WID are stored on a data carrier associated with the tool, in particular an RFID chip.

A rapid retrieval of the data in the production process is thus enabled and the production sequence can be designed efficiently and precisely.

In preferred exemplary embodiments, the 2D code is a data matrix code coding or a QR code coding.

In preferred exemplary embodiments, the tool data are retrieved via a direct data connection so that they arrive directly in the machine tool and are directly available there for further processing, wherein preferably the tool data are stored on the machine tool side after the retrieval and are used in the execution of a machining assignment. A very rapid and reliable retrieval of the data in the production process is thus enabled and the production sequence can be designed efficiently and precisely.

In preferred exemplary embodiments, the data interface is a tool data interface which corresponds to the UPC UA, Open Platform Communications Unified Architecture, and the interface comprises an OPC UA server. A particularly flexible use and an efficient data retrieval are thus enabled.

In preferred exemplary embodiments, the UPC UA is used for the communication with the tool management system and in particular for retrieving the tool data. A particularly flexible use and an efficient data retrieval are thus enabled.

In preferred exemplary embodiments, the tool data are retrieved from an OPC UA server via an OPC UA client as an OPC UA service call. A particularly flexible use and an efficient data retrieval are thus enabled.

In preferred exemplary embodiments, the tool data are converted into an input format after the retrieval (standardizing input format), said input format being predefined depending on the machine tool controller used. A particularly flexible use and an efficient data retrieval are thus enabled.

In further advantageous aspects, the following are proposed:

A computer program product comprising instructions which, when the program is executed by a control device of a numerically controlled machine tool, cause said machine tool to carry out the method according to at least one of the preceding features.

A control device for a machine tool having a data interface for connection to a tool management system and to an application-based control system. The control device may be configured to: acquire a unique tool identifier, hereinafter referred to as “WID”, of a tool to be picked up, and subsequently match the acquired WID with previously known tool identification data of the machine tool. If it is determined that the tool to be picked up is not yet known and/or updated tool data for the WID are available, then firstly tool data based on the acquired WID are automatically retrieved directly from the tool management system via the data interface. Alternatively, the tool data are automatically retrieved directly from the tool to be picked up. In the next step, a loading location for the tool to be picked up is determined based on the retrieved tool data, and preferably the tool is also picked up at the determined loading location.

The data interface of the control device is a tool data interface which corresponds to the UPC UA, Open Platform Communications Unified Architecture, wherein the interface comprises an OPC UA server.

Tool and tool data management in the field of machine tools currently represents a very great challenge and, in particular, there are currently a wide variety of ways in which tools with data come into contact with the machine. On the machine tool side, for this purpose it is in particular necessary for the tool data to be input and to be able to be used in the control and therefore a specific data format is present. For this purpose, different data formats are relevant, such as, for example, CNC or PLC.

In addition to the actual tools, the tool manufacturers also provide presetting devices and tool controls with which setpoint values, tolerance ranges and actual values for the respective tools can be determined or output. In this case, these presetting devices are designed to be operated by a human operator via a manufacturer-specific user interface. The precise operating steps, the designations and the presentation of the data differ here from manufacturer to manufacturer. Corresponding APIs are not available here; only the generic OPC UA protocol is supported for computer-implemented actuation. The OPC UA protocol is based on low-level instructions close to hardware, so that actuation via this protocol represents in practice a complex object which cannot currently be easily solved. This applies in particular when devices are actuated by foreign manufacturers with proprietary hardware. A particularly advantageous aspect in the present case is therefore the standardizing input format which represents a solution to the abovementioned problems with regard to the data and format conversions.

According to a further preferred embodiment according to at least one of the described features, the following is additionally proposed: An operating device for use on a numerically controlled machine tool, having a data processing device which is configured in particular to carry out control and operator control applications, a control interface via which the data processing device can be communicatively connected to a control device of the machine tool, and/or a user interface which is configured to accept input information according to operator control inputs of an operator of the machine tool and to transmit said input information to the data processing device and/or to output information transmitted by the data processing device to the operator. If it is determined that the tool to be picked up is not yet known and/or updated tool data for the WID are available, then firstly tool data based on the acquired WID are automatically retrieved directly (and preferably instantaneously) from the tool management system via the data interface. Preferably, a manual intervention (by the operator) is therefore no longer necessary for this purpose. Alternatively, the tool data are automatically retrieved directly (and preferably instantaneously) from the tool to be picked up. In the next step, a loading location for the tool to be picked up is determined based on the retrieved tool data, and preferably the tool is also picked up at the determined loading location. As a result of this configuration, an automated and efficient acquisition of the necessary (and current) tools with tool data is possible which can be used directly in the production process in order thus to significantly improve the efficiency in the use of the machine tool and in particular in the manufacture of workpieces. In addition, errors and waiting times in the tool acquisition/input are reduced or entirely avoided.

In preferred exemplary embodiments, the data processing device is configured to control a machining assignment for machining one or more workpieces on the machine tool on the basis of a machining step sequence, in particular a machining step sequence which can be selected by the operator via the user interface, and/or to call up corresponding machine or control functions on the control device via the control interface. A setup sequence of the tools is determined depending on the machining assignment, so that the loading locations of the tools are determined according to the machining assignment. In this embodiment, not only are the specific tool data automatically retrieved, but an optimal setup location for all required tools will additionally also be determined automatically.

In preferred exemplary embodiments, the data processing device is configured to control the machining assignment on the basis of machining step sequence data which are stored in a data storage device of the operating device and which are assigned to the machining step sequence.

In preferred exemplary embodiments, the machining step sequence data specify a plurality of machining steps and/or a predefined sequence of the plurality of machining steps.

In preferred exemplary embodiments, the plurality of machining steps comprises at least one or more of:
accept a machining assignment assigned to the machining step sequence,
set up or prepare one or more clamping means required for the machining assignment on the machine tool,
set up one or more tools required for the machining assignment on the machine tool,
load or prepare one or more tools required for the machining assignment on the machine tool,
load and/or program one or more NC codes, NC programs and/or NC program sections required for the machining assignment,
execute one or more NC codes, NC programs and/or NC program sections required for the machining assignment,
execute a process monitoring application,
document one or more machining processes assigned to the machining assignment,
carry out an automated quality check of one or more machined workpieces, and/or
output the machining assignment.

In preferred exemplary embodiments, the plurality of machining steps comprises at least one or more of:
automatic assembly of workpiece pallets,
automated loading of workpiece pallets,
automatic resorting of workpieces to workpiece pallets,
adjustment of a clamping position of a workpiece,
changing from one clamping position to another clamping position,
automatic measurement of workpieces,
automatic loading of a tool magazine of the machine tool,
automated setting up of tools on the machine tool,
automatic resorting of tools on the tool magazine, and/or
carrying out one or more cleaning, maintenance, maintenance and/or service applications on the machine tool.

In preferred exemplary embodiments, the machining step sequence data specify an assigned machining step application for each machining step of the machining step sequence. Preferably, the data processing device is configured to carry out the respectively assigned machining step application in order to control a machining step.

In preferred exemplary embodiments, the operating device furthermore comprises a network interface which is configured to connect the operating device to one or more servers via a communication network.

In preferred exemplary embodiments, the data processing device is configured, when at least one of the servers provides the execution of machining step applications as web applications according to a client-server communication, to carry out the assigned machining step application as web application according to the client-server communication with the at least one server via the network interface in order to control a machining step. The latter can additionally determine a setup sequence of the tools depending on a machining assignment, so that the loading locations of the tools are determined according to the machining assignment. In this embodiment, not only are the specific tool data automatically retrieved, but an optimal setup location for all required tools will additionally also be determined automatically.

In preferred exemplary embodiments, the data processing device is configured to retrieve input information and/or the required tool data required for the execution of a machining step application assigned to a machining step of the machining step sequence automatically from the external tool management system.

Preferably, the data processing device is configured to obtain or load input data and/or tool data required for the execution of a machining step application assigned to a machining step of the machining step sequence automatically via the network interface from one or more servers.

Preferably, the input data comprise one or more of:
model data indicating a CAD model of one or more workpieces, one or more workpiece parts and/or one or more tools,
NC data indicating one or more NC codes, one or more NC programs and/or one or more NC program sections,
order data indicating order data assigned to a workpiece machining,
tool data indicating information about one or more assigned tools,
tool list data indicating a list of tools assigned to a machining assignment or a workpiece machining,
clamping means data indicating information about one or more assigned clamping means, and/or
clamping means list data indicating a list of clamping means assigned to a machining assignment or a workpiece machining.

In preferred exemplary embodiments, the data processing device is configured to check or confirm, before the execution of a machining step sequence, whether or that input data required for each machining step application respectively assigned to the machining steps are present, in particular by the operator having been input, by the presence of loadable input data and/or by output data of a machining step application to be carried out beforehand.

A control device for use on a numerically controlled machine tool having a control device for controlling machine functions of the machine tool and an operating device according to one of the preceding aspects which is connected or can be connected to the control device and/or a machine tool having such a control device.

Further aspects and the advantages thereof as well as advantages and more specific possible embodiments of the above-described aspects and features are described from the following descriptions and explanations relating to the appended figures, which are not to be interpreted as limiting in any way.

### BRIEF DESCRIPTION OF THE FIGURES

FIG. 1 shows a schematic illustration of a system for operating and controlling one or more numerically controlled machine tools according to an exemplary embodiment of the present invention.

FIG. 2 shows a schematic illustration of the method according to an exemplary embodiment of the present invention.

FIG. 3 shows schematically the various abstraction levels from the graphical interface which the operator sees, via the backend, further via the standardization of the data structure, up to the input devices from a plurality of different manufacturers according to at least one exemplary embodiment of the present invention.

FIG. 4 shows, by way of example, the exchange of tool data between the machine tool WZM and the tool presetting device WV via the OPC UA protocol according to at least one exemplary embodiment of the present invention.

FIG. 5 shows, by way of example, the tool data exchange as an interface provided via OPC UA according to at least one exemplary embodiment of the present invention.

FIG. 6 shows, by way of example, an order selection screen of a graphical user interface of the user interface of the operating device of the machine tool according to at least one exemplary embodiment of the present invention.

FIG. 7 shows, by way of example, a tool inspection screen of the graphical user interface of the user interface of the operating device of the machine tool according to at least one exemplary embodiment of the present invention.

FIG. 8 shows, by way of example, a tool loading screen of the graphical user interface of the user interface of the operating device of the machine tool according to at least one exemplary embodiment of the present invention.

FIG. 9 shows, by way of example, a portion of the API specifications for the input format according to at least one exemplary embodiment of the present invention.

FIG. 10 shows, by way of example, a portion of the different specifications for the input format and the manufacturer's formats, which are required for controlling the tool controls and the presetting devices. On the basis of the lookup table illustrated, the formats can be converted into one another according to at least one exemplary embodiment of the present invention.

### DETAILED DESCRIPTION OF THE FIGURES AND PREFERRED EXEMPLARY EMBODIMENTS

Examples or exemplary embodiments of the present invention are described in detail below with reference to the appended figures. Identical or similar elements in the figures may in this case be denoted by the same reference numerals, but sometimes also by different reference numerals.

It should be emphasized that the present invention is not limited or limited in any way to the exemplary embodiments described below and the embodiment features thereof, but rather furthermore comprises modifications of the exemplary embodiments, in particular those which are comprised by modifications of the features of the described examples or by combination of individual or a plurality of the features of the described examples within the scope of protection of the independent claims.

Tool and tool data management in the field of machine tools currently represents a very great challenge and, in particular, there are currently a wide variety of ways in which tools with their data come into contact with the machine tool for use. On the machine tool side, for this purpose it is in particular usually necessary for the tool data to be input in order to be able to be used in the WZM controller and therefore a specific data format of the tool data is usually also necessary. This is usually determined by the WZM controller. Furthermore, presetting devices for setting or measuring tools are designed to be operated by a human operator via a manufacturer-specific user interface. The precise operating steps, the designations and the presentation of the data differ here from manufacturer to manufacturer. Corresponding APIs are not available here. On account of these diverse hurdles, automation in the machine tool controller currently represents a central problem with regard to tool data.

Consequently, it is advantageously proposed, by means of a tool management application on the WZM controller (for example “tool master”) combined with a special processing and provision of the tool data (for example “tool data exchange”), to create the possibility of connecting the entire WZM system directly to further data management systems which exist outside the machine tool, so that tool data which are present, for example, in a tool measuring device can be acquired and can be loaded directly into the WZM (or WZM controller or NC control device) via an identification of the tool on the machine, so that the workflow and the tool handling can be negotiated jointly and automatically via the tool data exchange application of the WZM controller.

For this purpose, a direct data connection is particularly advantageously proposed, i.e. the data can be exchanged directly via an interface, but the tool data can also be present in a cloud, so that when the tool is selected on the WZM controller, tool data arrive directly in the machine and are thus directly available in the WZM.

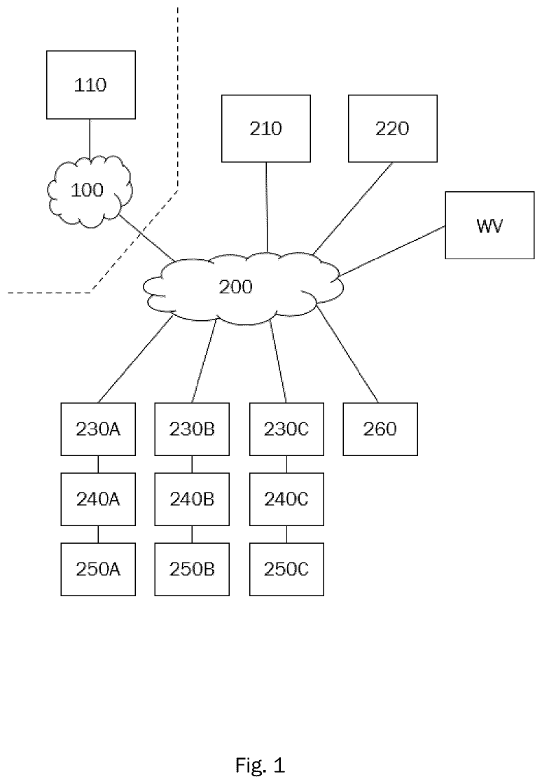

To explain the underlying system design, firstly the arrangement and connectivity of the WZM in a specific network is described. FIG. 1 shows a schematic, exemplary illustration of a system for operating and controlling one or more numerically controlled machine tools according to an exemplary embodiment of the present invention.

The system according to FIG. 1 comprises, by way of example, a web server 110 which is connected, by way of example, to a communication network 100, for example the Internet, a cloud service network or a local network.

Furthermore, the system according to FIG. 1 comprises, by way of example, a database server 210 and a CAD/CAM system server 220 which are connected, by way of example, to a communication network 200, preferably a local network (for example LAN, WLAN, etc.).

By way of example, the communication network 200 in FIG. 1 is connected to the communication network 100, wherein, by way of example, a firewall (dashed line) is provided between the communication network 100 and the communication network 200.

The system according to FIG. 1 furthermore comprises, by way of example, a numerically controlled machine tool 250A (for example a milling machine, a universal milling machine, a machining centre, a milling/turning machine, a turning machine, a turning centre, a grinding machine, a gear cutting machine, an application machine for additive manufacturing, etc.) having an NC control device 240A which is assigned to the machine tool 250A and which is connected to the machine tool 250A or preferably to controllable actuators and sensors of the machine tool 250A and which is configured to control the machine tool 250A or functions of the machine tool 250A. The control device 240A can be integrated, by way of example, on the machine tool 250A.

Furthermore, the system according to FIG. 1 comprises, by way of example, an operating device 230A which is assigned to the machine tool 250A and which is connected to the control device 240A assigned to the machine tool 250A. The operating device 230A is additionally connected, by way of example, to the communication network 200. By way of example, the operating device 230A is configured to communicate with the database server 210 and the CAD/CAM system server 220 via the communication network 200.

Furthermore, the operating device 230A is configured, by way of example, to communicate with the web server 110 via the communication network 200 and the communication network 100.

By way of example, the system according to FIG. 1 additionally comprises further numerically controlled machine tools 250B and 250C in each case having correspondingly assigned control devices 240B and 240C and in each case having correspondingly assigned operating devices 230B and 230C.

By way of example, the operating device 230A is configured to communicate with the operating devices 230B and 230C of the respective machine tools 250B and 250C via the communication network 200, and vice versa by way of example.

Furthermore, the system according to FIG. 1 comprises, by way of example, a separate operating device 260 (for example a user computer, such as for example a laptop, desktop PC, tablet or else a smartphone) which is connected to the communication network 200.

Furthermore, the system according to FIG. 1 comprises, by way of example, an external device WV which is suitable for providing and/or determining tool data, for example a presetting, balancing or shrinking device. In this case, the external device WV is connected to the communication network 200.

The operating device 230 can be formed or provided by means of a computer (for example a front-end PC integrated in an operating console of the machine tool or in the machine tool).

Furthermore, the operating device 230 comprises, by way of example, a user interface 233, TM UI or a front end and a network interface for establishing a communicative connection to the network 200 or to the network 100.

The TM UI or the front end is preferably a graphical user interface 233 (GUI) for the operator (for example comprising output functions via a screen and input functions via input devices, for example comprising a mouse, a keyboard, one or more touchscreens implemented on the screen, soft keys, rotary knobs, rotary knobs and/or keys, etc., and possibly output functions via further output devices such as for example LED information fields, lights, lamps, warning lights, audio outputs, etc.).

In terms of hardware, the control device 240 can be formed, in exemplary embodiments, for example on a computer, such as for example on the same computer as the operating device 230. Alternatively, the control device 240 can be implemented on its own computer, for example on a back-end PC of the machine tool, which can be integrated for example on the machine tool.

The web server 110 is configured, by way of example, to provide web-based data or web-based applications via the network 100 and to carry them out on request, for example by one or more of the operating devices 230 or 260, and to transmit corresponding data via the networks 100 and 200 to the requesting operating device 230 or 260.

By way of example, the operating device 260 can be formed as a computer which comprises both operating device software analogous to the operating device software of the operating devices 230 and optionally one or more CAD/CAM software applications.

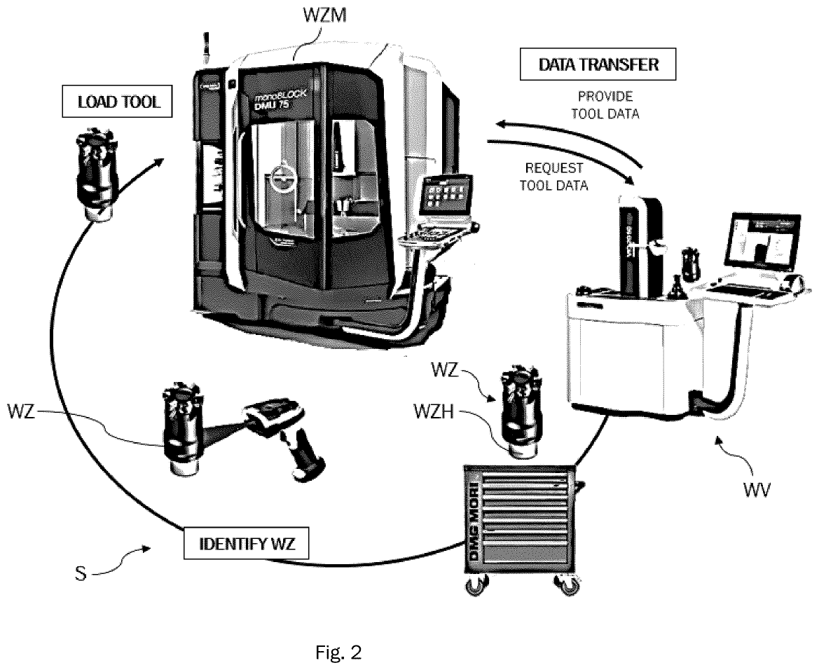

FIG. 2 shows a schematic, exemplary illustration of the method for processing tool data on a machine tool WZM having a data interface for connection to a tool management system. The method steps include: acquiring a unique tool identifier, hereinafter referred to as “WID”, of a tool WZ to be picked up, and subsequently matching the acquired WID with previously known tool identification data of the machine tool WZM. If it is determined that the tool WZ to be picked up is not yet known to the WZM and/or updated tool data for the WID are available, then firstly tool data (or updated tool data) based on the acquired WID are automatically retrieved directly from the tool management system via the data interface. Alternatively, the tool data (or updated tool data) are automatically retrieved directly from the tool WZ to be picked up. In the next step, a loading location for the tool WZ to be picked up is determined based on the retrieved tool data, and preferably the tool WZ is also picked up at the determined loading location.

The standardization of the measured tool data preferably takes place by a standardized input format which can be converted into the manufacturer's formats of all supported manufacturers and vice versa. As a result, the requests and responses to a manufacturer-specific presetting device WV can be mapped independently of the manufacturer. The control program for controlling the machine tool can then resort to the data in the standardized input format in the next step. In particular, tool data which have been measured using different presetting devices can thus also be compared with one another.

In addition to the actual tools, the tool manufacturers, for example S1, S2, S3, also provide presetting devices and tool controls with which, for example, setpoint values, tolerance ranges and actual values for the respective tools can be determined or output. In this case, these presetting devices are designed to be operated by a human operator via a manufacturer-specific user interface. The precise operating steps, the designations and the presentation of the data differ here from manufacturer to manufacturer. Corresponding APIs are not available here; only an M2M protocol, such as, for example, MQTT, MTConnect, AMQP, and particularly advantageously the generic OPC UA protocol is supported for computer-implemented actuation. The OPC UA protocol is based on low-level instructions close to hardware, so that actuation via this protocol represents in practice a complex object which therefore also requires particular qualification of the operator. This applies in particular when devices are actuated by foreign manufacturers with proprietary hardware. In the present embodiment, the standardized input format represents a solution to this complex object.

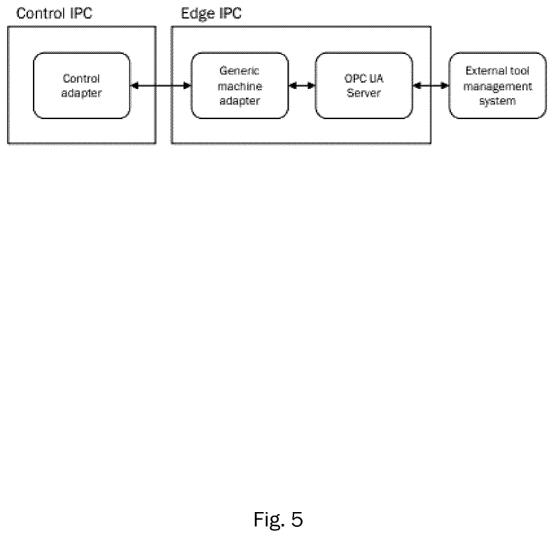

The exemplary data transfer takes place by a network inquiry via a tool data interface to the tool management system which is preferably present externally and provides data from the cloud, for example the communication network 100 and/or communication network 200, via the network connection. Upon request, the tool management system provides tool data for the devices connected to the communication network 100 or 200, such as, for example, the machine tool WZM or the machine tools 250A; 250B; 250C, the operating devices 230A; 230B; 230C, the NC control devices 240A; 240B; 240C, or the tool presetting device WV, see also FIG. 1. Optionally, the tool management system can process further requests via the communication network 100 or 200, see also FIG. 5.

The data interface of the control device 240 is, by way of example, a tool data interface which corresponds to the UPC UA, Open Platform Communications Unified Architecture, wherein the interface comprises an OPC UA server. Analogously, by way of example, the UPC UA is used for the communication with the tool management system and in particular for retrieving the tool data. Furthermore, by way of example, the tool data are retrieved from an OPC UA server via an OPC UA client as an OPC UA service call.

Preferably, the tool data are converted into an input format after the retrieval (on the machine tool controller side), said input format being predefined depending on the machine tool controller used.

By way of example, the WID is acquired during the scanning S, and a tool identification identifier of the tool WZ to be picked up is scanned. For this purpose, the machine tool WZ comprises, for example, a scanning device (integrated or connected thereto) for acquiring information which has been encoded such that it is suitable in particular for further data processing on at least one digital device. The encoding can be, for example, barcodes, 2D codes, or RFID chips. This type of encoding is particularly suitable if the corresponding information is attached directly to a tool, in particular to the tool WZ, and it can be relevant, for example, for the management, the handling, the localization, the identification, and/or the description of the tool. According to one exemplary application, the information can be attached directly to the tool, in particular to the tool WZ, in that it is preferably engraved by laser, or alternatively a sticker is printed and correspondingly adhesively bonded to the tool. Optionally, this procedure is also possible for workpieces which are inserted into the WZM. Data of the workpiece can therefore be retrieved automatically by a workpiece management system (for example, cloud-based) via the automatic retrieval, after the scanning of an ID of the workpiece.

The acquisition of information by scanning device is advantageous over conventional methods in which the acquisition of information takes place by human intervention, for example by the operator of the WZM. From the prior art, conventional methods are known in which the operator has to manually read information from the tool and has to enter this information manually at the WZM controller. In this case, transmission errors can occur which can be minimized or ruled out by automated methods, such as during scanning S. Furthermore, the acquisition of information by scanning device takes less time and is thus suitable in particular for time-optimized work.

The tool data comprise measured values and/or setting values of the tool WZ which have been determined by an external device, in particular by the tool presetting device WV, by a balancing or shrinking device.

The data stored in the input format include inter alia the tool data. The tool data comprise the measured data of the presetting device WV and possibly further data relating to tool properties which are not acquired by the presetting device WV. The measured data can include inter alia:
length
thickness
weight
tolerance range
number of free spaces required in the tool magazine count.

The further data relating to additional tool properties may include, inter alia:
acquisition date
tool history
number of use
last job in which this tool was used count.

Furthermore, the data stored in the input format also include inter alia the WID. The WID are illustrated on the basis of a unique ID, for example on the basis of a Unique Device Identification (UDI). To ensure the uniqueness of the ID in the entire scope of application, a central server, for example a UDI server, can be used to assign the IDs. In particular, in the case of the UDI, a global UDI server is used which issues unique IDs worldwide, see also FIG. 5.

By way of example, the previously known tool identification data are stored on a memory on the machine tool, in particular an internal memory of the machine tool or the machine tool controller. Furthermore, the WID and/or tool data can be attached directly to the tool WZ or to the tool holder WZH in a machine-readable manner by way of example in order to be retrieved by the method step of the scanning S. In particular, the tool data and/or the WID can be attached in a machine-readable manner as follows:
store in a database (for example in the cloud or on an external server);
permanently attach to the tool WZ, in particular as an engraved code or printed 2D code;
temporarily store on the tool WZ, in particular as a printed sticker, wherein the sticker is preferably printed with a 2D code; and/or
store on a data carrier associated with the tool WZ (for example attached to the tool), in particular an RFID chip.

The data are preferably attached physically directly to the corresponding tool WZ. This offers the advantage that the data can always be accessed when the tool WZ can be accessed. Encodings which have been designed specifically for reading in by digital devices are particularly advantageous. These include in particular optical encodings such as 2D codes.

For this purpose, the present invention supports both the reading in of the data matrix code coding and the reading in of the QR code coding.

An alternative variant for attaching information directly to the tool WZ is the writing on of RFID chips which are integrated directly into the tool WZ. This variant is advantageous over a database since they are attached directly to the tool in a similar manner to 2D codes.

The permanent data storage by engraving by a laser on the tool is advantageous over conventional methods in which the information attachment is attached to the tool in a manner which enables the corresponding information to be able to be separated from the tool, or the corresponding information to become erroneous over time or as a result of external influences to be expected. In comparison to being glued with a sticker which is inscribed with relevant information, the engraving can have advantages. The adhesive surface of the sticker can lose its adhesion over time or as a result of external influences, so that the sticker is lost and the relevant information can no longer be assigned to the tool WZ. Likewise, the material of the sticker or the colorant used for inscribing can be damaged by normal work, so that the relevant information can only be assigned to the tool in parts or incorrectly.

By way of example, the tool data are retrieved via a direct data connection so that they arrive directly in the machine tool WZM or WZ and are directly available there for further processing, wherein preferably the tool data are stored on the machine tool side after the retrieval and are used in the execution of a machining assignment.

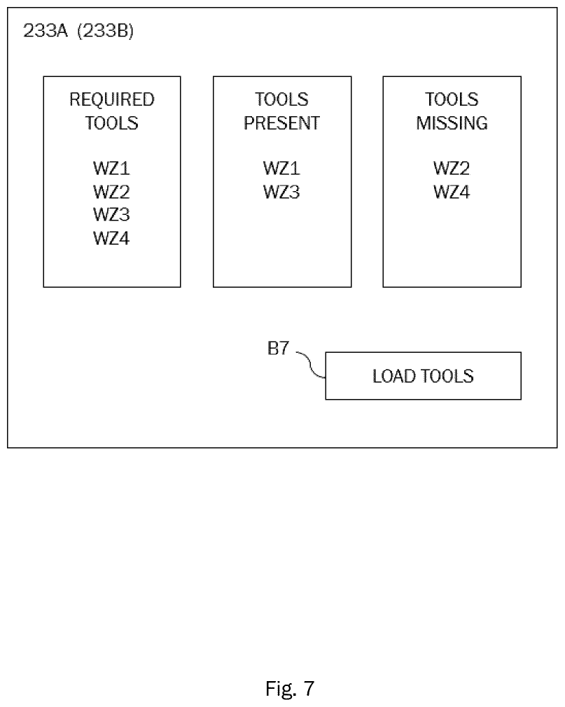

By way of example, an NC program is scanned for required tools, for example WZ1, WZ2, WZ3 and WZ4, and a difference list is preferably created. The difference list is created by comparing the tools required for a machining assignment with the tools already present, for example WZ1 and WZ2. Subsequently, one or more tools to be replaced, for example WZ3 and WZ4, are determined on the basis of the difference list. A predetermined setup location for the replacement is determined for the determined tools, for example WZ3 and WZ4. In this case, a setup sequence of the tools is determined depending on a machining assignment, so that the loading locations of the tools are determined according to the machining assignment. See also FIG. 7.

The first step of the loading process is, for example, the finding of a free space in the machine tool WZM, wherein the machine tool WZM comprises, for example, a tool magazine into which the tool can be loaded. For this purpose, the claimed size of the tool to be loaded is determined inter alia on the basis of the data stored in the input format. Subsequently, a correspondingly large and free space is sought. If no such space has been found in the machine tool WZM or in the tool magazine, an error message is output which explains the problem. Otherwise, the machine tool WZM or the tool magazine is brought into position in order to enable the loading at the correspondingly free space.

In the next step, the tool flap of the machine tool WZM or of the tool magazine is opened and instructions are output as to how the machine tool WZM or the tool magazine is to be loaded. The loading can also proceed in an automated manner. In the automated method, it is now waited until the tool flap has been closed again. At this point, the corresponding tool has to be loaded into the free space of the machine tool WZM or of the tool magazine. This can either take place manually by the operator or in an automated manner by an external system. By closing the tool flap, it is signaled that the tool, for example WZ2 or WZ4, has been loaded, and the loading process can be continued.

As the last step, it is checked (optionally) whether the tool has been loaded correctly. If the check fails to be negative, a corresponding error message is output which explains the problem. If the check fails to be positive otherwise, the loading process for this tool is considered to be concluded and the next method step is carried out. The next method step is, for example, either the loading process of a further tool or the automated execution of a machining assignment.

If the difference list is empty, the machining assignment is executed automatically. Otherwise, one of the missing tools is selected on the difference list and its tool data and identification data are retrieved in the input format. The determined setup sequence is preferably maintained during the selection of the tool to be set up from the difference list. The loading process for the tool is initiated on the basis of these data. After the loading process has been successfully concluded, the entry of the loading tool from the list of missing tools is deleted and instead added to the list of tools present. This step is repeated until all missing tools have been loaded on the difference list and the execution of the order is begun.

For the automatic loading, the computer program product can directly use the data in the input format since the tool data contains, inter alia, all the information necessary for the loading, such as, for example, the number of spaces to be occupied in the tool magazine.

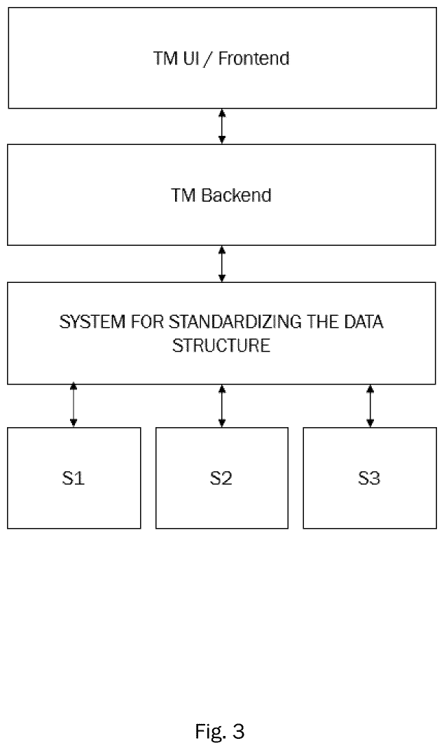

FIG. 3 shows schematically the various abstraction levels from the graphical user interface 233 which the operator sees, via the backend, further via the standardization of the data structure, up to the input devices from a plurality of different manufacturers, for example S1, S2 and S3, according to an exemplary embodiment of the present invention.

The TM UI or the front end is preferably a graphical user interface 233 (GUI) for the operator (for example comprising an output functions via a screen, with at least one screen area 233A, and input functions via input devices, for example comprising a mouse, a keyboard, one or more touchscreens implemented on the screen, soft keys, rotary knobs, rotary knobs and/or keys, etc., and possibly output functions via further output devices such as for example LED information fields, lights, lamps, warning lights, audio outputs, etc.).

The TM backend preferably corresponds to the tool management system. In this case, the TM front end of the machine tool is connected to the tool management system via a data interface. In particular, tool data based on an acquired WID can be automatically retrieved directly from the tool management system via the data interface. The data are present in the input format.

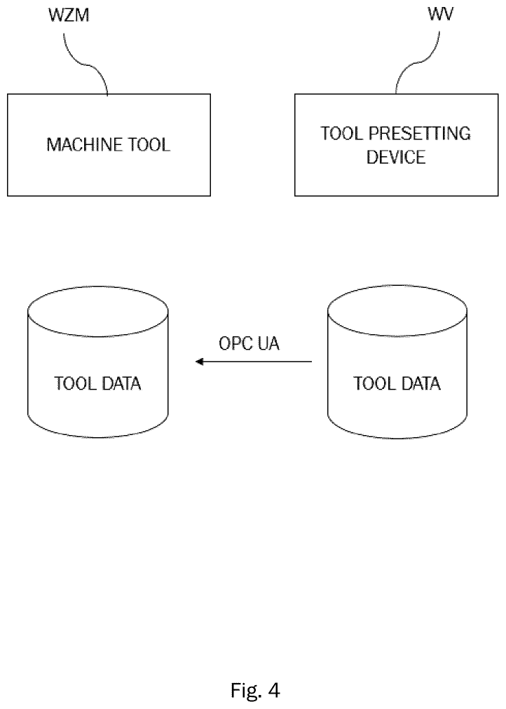

The system for standardizing the data structure preferably corresponds to the conversion from at least one manufacturer's format or from the OPC UA protocol into the standardizing input format or to the conversion of the standardizing input format into at least one manufacturer's format or into the OPC UA protocol. The manufacturer's devices S1; S2; and S3 can be used to communicate in the respective manufacturer's format or via the OPC UA protocol. FIG. 4 shows, by way of example, schematically, the exchange of tool data between the machine tool WZM and the tool presetting device WV via the OPC UA protocol.

Tool data are present on the tool presetting device WV and are uniquely identified with the tool holder WZH, for example via a QR code. The tool WZ is scanned and thus identified at the scanner during the method step of scanning S. The data of the tool WZ are then written via the OPC UA interface from the database in the presetting device WV into the tool table of the machine tool. The central database can be located, for example, in the tool presetting device WV.

FIG. 5 shows, by way of example, schematically, the tool data exchange as an interface provided via OPC UA. In particular, the figure shows the connection of the control adapter as part of the control IP to the preferably external tool management system. The connection takes place via the edge IPC which comprises the generic machine adapter and the OPC UA server. Overall, there are connections between the control adapter and the generic machine adapter, between the generic machine adapter and the OPC UA server, and between the OPC UA server and the preferably external tool management system. In particular, the control adapter can be present, by way of example, as PLC/NC agent, wherein the generic machine adapter is present as Machine Communication X. Alternatively, by way of example, the control adapter can be present, by way of example, as UDI server, wherein the generic machine adapter is present as UDI client.

If the control adapter is present, by way of example, as UDI server, and the generic machine adapter is present as UDI client, then the UDI client, if necessary, provides a request to the UDI server to generate a unique WID which is provided to the tool management system via the OPC UA server. In this case, the UDI server ensures that the allocated WIDs are actually globally unique.

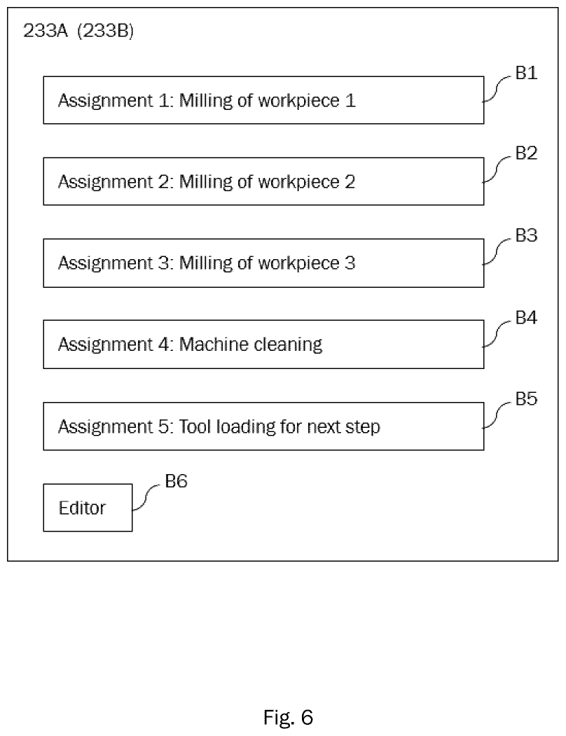

FIG. 6 shows, by way of example, schematically, an order selection screen of the graphical user interface of the user interface 233 of the operating device 230 of the machine tool 250.

By way of example, the order selection elements B1 to B5 are provided, via which the operator can select the orders 1 to 5. Preferably, the selection of the corresponding orders at the operating device 230 can be selected according to the order only by operators who have sufficient authorization. This can take place, for example, by different user roles on the basis of the capability or training of the operator, for example by means of the user roles: simple machine operator, experienced machine operator, machine loader, setter-up, machine programmer, machine maintenance provider, multi-machine operator, tool presetter, work preparer, factory planner, process standardizer, etc.

The selection element B6 enables, by way of example, the starting of an editor application for executing the machining step sequence editor at the graphical user interface of the user interface 233 of the operating device 230 of the machine tool 250. The editor application is configured to list the machining step applications provided at the web server 110 and to import them upon selection of the operator. The operator can additionally determine or define the sequence of the imported machining step applications and store predefined machining step sequences. This editor functionality can preferably be made available only to operators with a specific authorization.

The editor preferably indicates for each machining step application which input data or input information are required or automatically retrieved, which output data or output information are provided and/or which control functions of the machine tool are called up.

In preferred exemplary embodiments, when storing an edited machining step sequence, an automatic plausibility check can be carried out, in which it is checked in an automated manner for each machining step application whether the required input data are available (data availability check), either by manual input at the editor, by provision as output data of a preceding machining step application in the predefined sequence, from the storage device of the operating device, from the control device, from PLC registers, or by access to database data on the database server 210 and/or the CAD/CAM system server 220. The required data can also comprise tool data, specifically the tool data measured values and/or setting values of the tool which have been determined by an external device, in particular a presetting, balancing or shrinking device. These specific data are advantageous in particular for the even more precise use of the tool on the machine tool, wherein the individual provision of the data via the automated data retrieval has the particular advantage that the most up-to-date measured values and/or setting values of the tool which is actually to be replaced are automatically available on the machine tool and the production sequence can be designed efficiently and precisely.

In particular, the data availability will preferably be checked not only when storing an edited or created machining step sequence, but also when linking a new job to a machining step sequence or when starting a machining step sequence linked to a job or optionally when also still during (or respectively before) the execution of the corresponding machining step applications.

When executing a predefined machining step sequence by the operator on the operating device 230, preferably only each machining step application can be called up and executed in the sequence predefined by the stored or imported machining step sequence, and in particular no machining step application can be skipped. The tool data are particularly advantageously only retrieved when the tool is actually required in the machining process in the next machining step of the sequence. The tool data are therefore only promptly retrieved according to the just-in-time principle, which can relieve the memory load and computing power of the control. Optionally, the tool data can be deleted again on the WZM controller after the last use in the machining process and only automatically retrieved again from the external tool management system when the tool is used again.

The WZM particularly advantageously provides the external tool management system with detailed feedback about the use (duration and extent of use and, for example, working temperatures, applied forces, exceeding of limit values etc.) of the (each) tool, so that the tool history in the external tool management system is always up-to-date and the tool is always linked to the most up-to-date tool data even when changing to another WZM.

The execution of a predefined machining step sequence assigned to an order by the operator on the operating device 230 is triggered by the operator by selecting one of the order selection elements B1 to B5, which are assigned to a respective machining assignment, at least insofar as its authorization permits this.

When a respective machining step application is started by the operator, a new window of the corresponding machining step application can be opened and a validity check can be carried out (e.g. including data availability check). In addition, machine functions assigned to the respective machining step application can be executed.

Furthermore, in preferred exemplary embodiments, a screen representation assigned to the respective machining step or a control menu assigned to the respective machining step can be automatically called up on the other screen area, for example the screen area 233B, which shows a control screen of the control device 240. This can be requested or automatically set via the TM UI or the front end.

A first machining step application (e.g. “accept order”) can indicate the order header data to the operator, e.g. on the basis of the order data of an order to be executed, wherein the assigned order file is imported by the database server 210.

By confirming the machining step application (e.g. “accept order”), the order can be set to the status “execution”. This can also be automatically reported to a production monitoring system via the network 200.

A further (optional) machining step application can relate to the loading of tools or the checking of the tool requirement, see FIG. 7.

The order data of an order file (e.g. order database) assigned to the corresponding workpiece machining assignment can indicate e.g. one or more of the following header data: a designation of the work operation, an order identification number, an order description, a workpiece identification number, a workpiece description, a setting identification number assigned to the order, an assigned customer identification number, a workplan identification number, an indication of the desired or to be achieved piece number (i.e. e.g. a number of the quantity to be manufactured e.g. in the case of analogous machining of a plurality of workpieces one behind the other in the same workpiece machining assignment), a planned start time, a planned end time, a planned or calculated machining duration and optionally optional information of a free text field. Such data can also be provided from an ERP or MES system.

The data storage device of the database server 210 optionally stores, by way of example, a plurality of tool files (e.g. tool database), wherein each tool file provides or indicates information about an assigned tool, such as e.g. one or more of: tool dimensions (size, diameter, length, cutting edge type, cutting edge number etc.), tool type, tool identification number, etc.

FIG. 7 shows, by way of example, schematically, a tool inspection screen of the graphical user interface of the user interface 233 of the operating device 230 of the machine tool 250.

In this case, the required tools, for example WZ1, WZ2, WZ3, and WZ4, are indicated (e.g. on the basis of a tool list file assigned to the order to be executed). In addition, on the basis of the data present on the operating device, the tools present on the machine tool WZ, for example WZ1 and WZ3, can be displayed and the tools still missing or still to be loaded, for example WZ2 and WZ4.

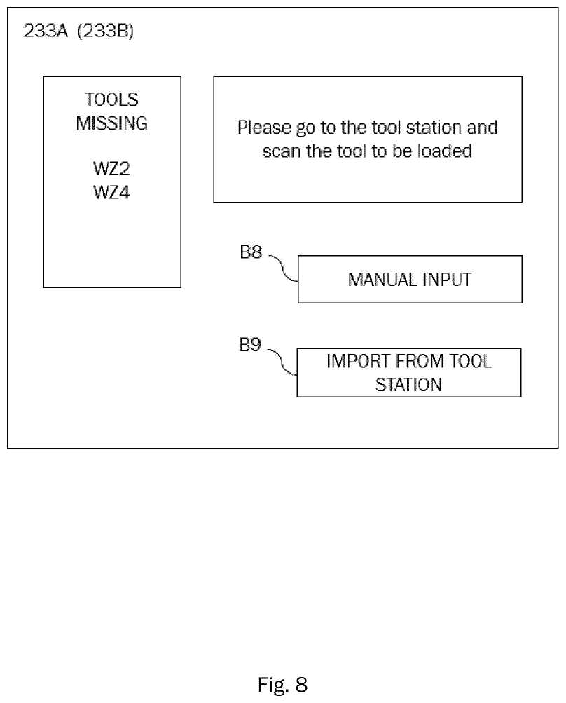

By actuating the selection element B7 “load tools”, the operator can move to the tool loading in order, if appropriate, to load the missing tools or to enter the associated tool data (or to either import these from the tool data, if already previously scanned, or to import them from a tool presetting device connected to the network 200 after the scanning S of the tool), see e.g. FIG. 8.

FIG. 8 shows, by way of example, schematically, a tool loading screen of the graphical user interface of the user interface 233 of the operating device 230 of the machine tool 250.

By actuating the selection element B8 “manual input”, the operator can scan the missing tools before the loading at the tool station and then enter the data manually or import these from a tool presetting device connected to the network 200 by actuating the selection element B9 “import from tool station”. The input of the data as described takes place particularly advantageously in an automated manner during the scanning process when the tool is replaced, in particular without the operator's involvement.

A further (optional) machining step application can relate to the loading or programming of the NC code. In this case, NC files assigned to the order are indicated (e.g. on the basis of the order data of an assigned order file) and these can be exported to the control device 240 by actuating a corresponding selection element “load NC file into NC” (if appropriate after importing the corresponding file(s) from the CAD/CAM system server 220). By selecting the selection element B10 “edit NC file”, the operator can edit (or newly create) a loaded file in the display window situated thereabove, for example, at least if the required authorization of the operator is present.

After tool loading, if appropriate clamping means set-up and NC code provision in sequence and manner according to the predefined machining step sequence (and if appropriate after further predefined steps), the workpiece machining can be carried out, if appropriate in conjunction with predefined process monitoring, subsequent process documentation and if appropriate optional quality check, until the order can be confirmed as finished or executed in an automated manner in a last machining step.

The WZM particularly advantageously provides the external tool management system with detailed feedback about the use (duration and extent of use and, for example, working temperatures, applied forces, exceeding of limit values etc.) of the (each) tool, so that the tool history in the external tool management system is always up-to-date and the tool is always linked to the most up-to-date tool data even when changing to another WZM.

According to one or more of the preceding exemplary embodiments, the operation or control of a machine tool can be extended and improved, in particular with regard to the operability or the automation or semi-automated support of machining steps of a workpiece machining assignment, if appropriate also by partially untrained or less experienced operators.

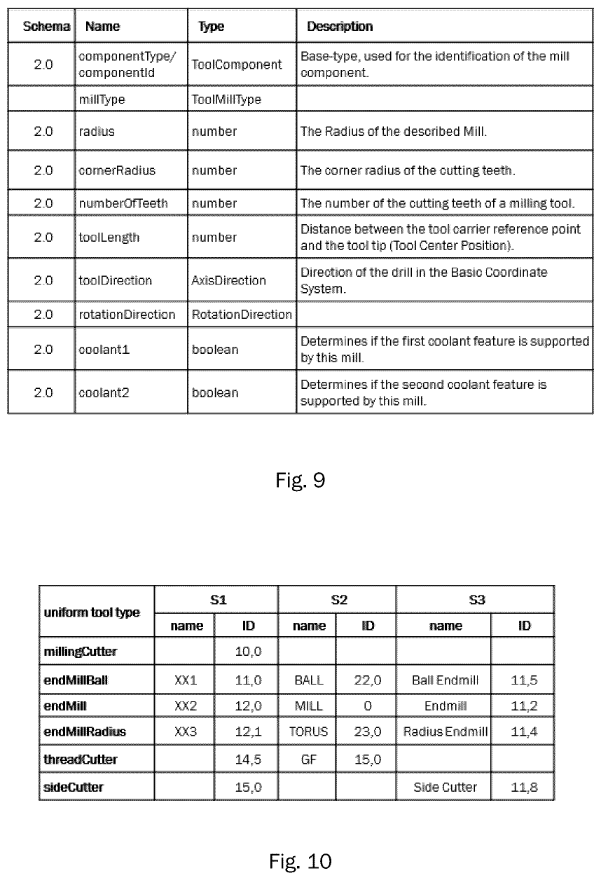

FIG. 9 shows, by way of example, a portion of the API specifications for the input format. The input format is present in the JSON format, for example.

In this case, the column “Schema” represents the version number of the input format. Using the field “Schema”, it is possible to distinguish different versions of the input format. This is advantageous in particular since the API specifications of different versions thus do not have to be compatible with one another.

In addition, the column “Name” represents the name on the basis of which a field in the input format can be read, created, overwritten or deleted.

Furthermore, the column “Type” represents the data type of the field in the input format. The data type defines the binary presentation or the human-readable presentation in the input format. Furthermore, the data type defines the parsing for converting the field.

Finally, the column “Description” represents a description which can be used by the operator to interpret the meaning of a field in the input format.

FIG. 10 shows, by way of example, a portion of the different specifications for the input format and the manufacturer's formats, which are required for controlling the tool controls and the presetting devices. The formats can be converted into one another on the basis of the lookup table illustrated.

In this case, the column “Uniform Tool Type” represents a manufacturer-agnostic tool type designation. It is thus possible to combine equivalent tools from different manufacturers under one term and, during the conversion between different data formats, to assign the equivalent fields to one another.

Furthermore, the next columns represent the manufacturers S1; S2; and S3. The respective manufacturer's columns are further subdivided into “name”, the manufacturer's own designation of the tool type, and “ID”, a cross-manufacturer ID. The “name” is respectively unique to a fixed manufacturer and is allocated by the manufacturer and is used in the manufacturer's format. By contrast, the “ID” is defined by the input format and the manufacturer's own designation “name”, the manufacturer S1; S2; or S3, and the manufacturer's agnostic tool type designation “Uniform Tool Type” can be resolved uniquely on the basis of the ID.

In summary, tool and tool data management in the field of machine tools currently represents a very great challenge and, in particular, there are currently a wide variety of ways in which tools with data come into contact with the machine. On the machine tool side, for this purpose it is in particular necessary for the tool data to be input and to be able to be used in the control and therefore a specific data format is present. For this purpose, different data formats are relevant, such as, for example, CNC or PLC.

CNC is understood to mean a numerical control which comprises one or more microprocessors for the execution of the control functions. External identifiers of a CNC are usually a screen and a keyboard. The numerical control (CNC) is operated with a CNC program which comprises all the required functions, such as, for example, interpolation, position control and speed control. With the aid of the one or more microprocessors and the CNC program, a workpiece-dependent CNC part program is executed which is generally specified by the user of the machine.

A CNC part program consists of an arbitrary number of sets which describe the entire working sequence of the machine for machining a workpiece step by step. Each set in the program represents a geometrical machining step and/or a specific machine function. A set can contain different instructions. A distinction is made here between
geometrical instructions with which the relative movements between tool and workpiece are controlled;
technological instructions with which feed speed, spindle speed and tools are determined;
travel instructions which determine the type of movement, such as, for example, rapid traversal, linear interpolation, circular interpolation and plane selection;
switching commands for selecting the tools, switching table positions, coolant supply;
correction calls, for example for tool length correction, milling cutter diameter correction, cutting edge radius correction and zero point displacement; and
cycle and subprogram calls for frequently recurring program sections.

In addition to the numerical control, the CNC program and the CNC part program, an adaptation program (PLC program) to the machine to be controlled is additionally required, which is created by the machine manufacturer and integrated into a programmable logic controller (PLC). All machine-related links and locks for specific functional sequences are determined therein, such as, for example, for tool change, workpiece change and the axis boundaries.

Some differences are to be emphasized for further delimitation between CNC and PLC. A CNC part program for machining the workpieces is created by the machine user. CNC part programs can be changed or modified arbitrarily by the user. By contrast, a PLC program is created by the machine manufacturer and stored captively, for example on a ROM (read only memory). The PLC program only has to be changed or replaced in exceptional cases. In particular, no programming takes place during operation in the case of the PLC. PLC programs have to be created for each PLC (programmable logic controller) and are not complicatable for other PLC manufactures. On the basis of this central difference, it emerges that there can be up to several thousand CNC part programs per machine. The CNC part programs are created by the machine user, fixed cycles and subprograms can certainly be supplied by the manufacturer. For a PLC, there is generally only a single fixed, plant-related program. The program is created by the machine manufacturer, usually using available functional modules.

Machine tools are respectively equipped on a customer-specific basis. Therefore, it is very complex for the service technician to find out in advance the software versions required precisely for this customer and to find out the appropriate software for the respective customer.

There are different manufacturers of central components within the machine tool, such as, for example, PLC and NC. The dependencies on manufacturers, versions, updates and special equipment have to be managed efficiently, so that it is ensured that the software updates appropriate to the machine are always used.

Consequently, it is advantageously proposed, by means of a tool management application on the WZM controller (for example “tool master”) combined with a special processing and provision of the tool data (for example “tool data exchange”), to create the possibility of connecting the entire WZM system directly to further data management systems which exist outside the machine tool, so that tool data which are present, for example, in a tool measuring device can be acquired and can be loaded directly into the WZM (or WZM controller or NC control device) via an identification of the tool on the machine, so that the workflow and the tool handling can be negotiated jointly and automatically via the tool data exchange application of the WZM controller.

Examples or exemplary embodiments of the present invention as well as the advantages thereof have been described in detail above with reference to the appended figures. It should be emphasized again that the present invention is not limited or limited in any way to the above-described exemplary embodiments and the embodiment features thereof, but rather furthermore comprises modifications of the exemplary embodiments, in particular those which are comprised by modifications of the features of the described examples or by combination of individual or a plurality of the features of the described examples within the scope of protection of the independent claims.

Reference sign list:

| | |
|---|---|
| 100: | communication network |
| 110: | web server |
| 200: | communication network |
| 210: | database server |
| 220: | CAD/CAM system server |
| 230: | operating device |
| 230A; 230B; 230C: | first operating device; second operating device; |
| | third operating device |
| 233: | user interface |
| 233A; 233B: | first screen area; second screen area |
| 240: | control device |
| 240A; 240B; 240C: | first NC control device; second NC control |
| | device; third NC control device |
| 250A; 250B; 250C: | first machine tool; second machine tool; third |
| | machine tool; |
| 260: | separate operating device |
| B1; B2; B3; B4; B5: | selection element for job 1; job 2; job 3; |
| | job 4; job 5 |
| B6: | selection element for editor application |
| B7: | loading selection element for tools |
| B8: | selection element for manual input |
| B9: | selection element for import from tool station |
| S: | scanning |
| S1; S2; S3: | tool control of a first; second; third |
| | manufacturer |
| WV: | presetting device |
| WZ: | tool |
| WZ1; WZ2; WZ3; WZ4: | tool 1; tool 2; tool 3; tool 4 |
| WZH: | tool holder |
| WZM: | machine tool |

1. A method for processing tool data on a machine tool having a data interface for connection to a tool management system, wherein
the method comprises the steps of:
acquiring a unique tool identifier, WID, of a tool to be picked up;
matching the acquired WID with previously known tool identification data of the machine tool;
if it is determined that the tool to be picked up is not yet known and/or updated tool data for the WID are available:
automatically, via the data interface, retrieving tool data directly from the tool management system based on the acquired WID or automatically retrieving the tool data directly from the tool to be picked up;
determining a loading location for the tool to be picked up based on the retrieved tool data and preferably, picking up the tool at the determined loading location.

2. The method according to claim 1, wherein
acquiring the WID comprises scanning a tool identification identifier of the tool to be picked up.

3. The method according to claim 1, wherein
the tool management system is an external tool management system for providing data from the cloud and the data interface is a tool data interface which is connected to the external tool management system via a network connection.

4. The method according to claim 1, wherein
the tool data comprise measured values and/or setting values of the tool which have been determined by an external device, in particular a presetting, balancing or shrinking device.

5. The method according to claim 1, wherein
in order to create a difference list, the tools required for a machining assignment are compared with the tools already present, and wherein
one or more tools to be replaced are determined on the basis of the difference list.

6. The method according to claim 1, wherein
the method initially comprises the step of scanning an NC program for required tools and preferably creating a corresponding difference list.

7. The method according to claim 1, wherein
a predetermined setup location for the tool to be replaced is determined.

8. The method according to claim 1, wherein
the method additionally determines a setup sequence of the tools depending on a machining assignment, so that the loading locations of the tools are determined according to the machining assignment.

9. The method according to claim 1, wherein
the previously known tool identification data are stored on a memory on the machine tool, in particular an internal memory of the machine tool or the machine tool controller.

10. The method according to claim 1, wherein
the WID and/or tool data are attached directly to the tool or tool holder in a machine-readable manner in order to be retrieved by scanning.

11. The method according to claim 1, wherein
the tool data and/or the WID are stored in a database;
the tool data and/or the WID are permanently attached to the tool, in particular as an engraved code or printed 2D code;
the tool data and/or the WID are temporarily stored on the tool, in particular as a printed sticker; and/or
the tool data and/or the WID are stored on a data carrier associated with the tool, in particular an RFID chip.

12. The method according to claim 1, wherein
the 2D code is a data matrix code coding or a QR code coding.

13. The method according to claim 1, wherein
the tool data are retrieved via a direct data connection so that they arrive directly in the machine tool and are directly available there for further processing, wherein
preferably the tool data are stored on the machine tool side after the retrieval and are used in the execution of a machining assignment.

14. The method according to claim 1, wherein
the data interface is a tool data interface which corresponds to the UPC UA, Open Platform Communications Unified Architecture, and wherein
the interface comprises an OPC UA server.

15. The method according to claim 1, wherein
the UPC UA, Open Platform Communications Unified Architecture, is used for the communication with the tool management system and in particular for retrieving the tool data.

16. The method according to claim 1, wherein
the tool data are retrieved from an OPC UA server via an OPC UA client as an OPC UA service call.

17. The method according to claim 1, wherein
the tool data are converted into an input format after the retrieval, said input format being predefined depending on the machine tool controller used.

18. A non-transitory computer readable medium, storing instructions for processing tool data on a machine tool having a data interface for connection to a tool management system, wherein
the instructions, when executed by a control device of a numerically controlled machine tool, cause said machine tool to carry out a process comprising:
acquiring a unique tool identifier, WID, of a tool to be picked up;
matching the acquired WID with previously known tool identification data of the machine tool;
if it is determined that the tool to be picked up is not yet known and/or updated tool data for the WID are available:
automatically, via the data interface, retrieving tool data directly from the tool management system based on the acquired WID or automatically retrieving the tool data directly from the tool to be picked up;
determining a loading location for the tool to be picked up based on the retrieved tool data and preferably, picking up the tool at the determined loading location.

19. A control device for a machine tool having a data interface for connection to a tool management system and to an application-based control system, said control device being configured to:
acquire a unique tool identifier, WID, of a tool to be picked up;
match the acquired WID with previously known tool identification data of the machine tool;
if it is determined that the tool to be picked up is not yet known and/or updated tool data for the WID are available:
automatically, via the data interface, retrieving tool data directly from the tool management system based on the acquired WID or automatically retrieving the tool data directly from the tool to be picked up;
determine a loading location for the tool to be picked up based on the retrieved tool data and preferably, pick up the tool at the determined loading location.

20. The control device according to claim 19, wherein
the data interface is a tool data interface which corresponds to the UPC UA, Open Platform Communications Unified Architecture, and wherein
the interface comprises an OPC UA server.

21. The control device of claim 19, wherein the control device is part of the machine tool.
